(19) United States
(12) Patent Application Publication
(10) Pub. No.: US 2018/0241906 A1
(43) Pub. Date: Aug. 23, 2018

(54) IMAGE FORMING APPARATUS, METHOD OF CONTROLLING AN IMAGE FORMING APPARATUS, AND A NON-TRANSITORY RECORDING MEDIUM

(71) Applicants: KABUSHIKI KAISHA TOSHIBA, Tokyo (JP); TOSHIBA TEC KABUSHIKI KAISHA, Tokyo (JP)

(72) Inventor: Rie SUZUKI, Izunokuni Shizuoka (JP)

(21) Appl. No.: 15/440,676

(22) Filed: Feb. 23, 2017

(51) Int. Cl. H04N 1/32; H04N 1/04

(52) U.S. Cl. CPC H04N 1/32133; H04N 1/04; H04N 2201/3226; H04N 2201/0094; H04N 1/32122

(57) ABSTRACT

An image forming apparatus is disclosed, including a printer section, an image reading section configured to read image information printed on a sheet and generate image data from the image information, and a controller configured to control the printer section to print the image data along with additional information input, or selected from a list, by a user.

### FIELD

Embodiments described herein relate generally to an image forming apparatus, a method of controlling an image forming apparatus, and a non-transitory recording medium.

### BACKGROUND

Conventionally, at the time of copying an image from a sheet using a copying machine, it is possible to add information such as a date and number of copies to the header or the footer through a function of the copying machine.

However, conventional copying machines are not flexible in what information can be added and how it can be added.

### BRIEF DESCRIPTION OF THE DRAWINGS

FIG. 1 is an external view illustrating an example of the configuration of an image forming apparatus according to an embodiment;

FIG. 2 is a block diagram illustrating functional components of the image forming apparatus;

FIG. 3 is a flowchart illustrating the flow of a processing by the image forming apparatus; and

FIG. 4 is a diagram illustrating a print image in a case in which a list is selected.

### DETAILED DESCRIPTION

In accordance with an embodiment, a printing apparatus includes a printer section, an image reading section and a controller. The image reading section reads image information printed on a sheet and generates image data from the image information. The controller controls the printer section to print the image data along with additional information input, or selected from a list, by a user.

Hereinafter, an embodiment of an image forming apparatus, a printing method and a non-temporal recording medium are described with reference to the accompanying drawings.

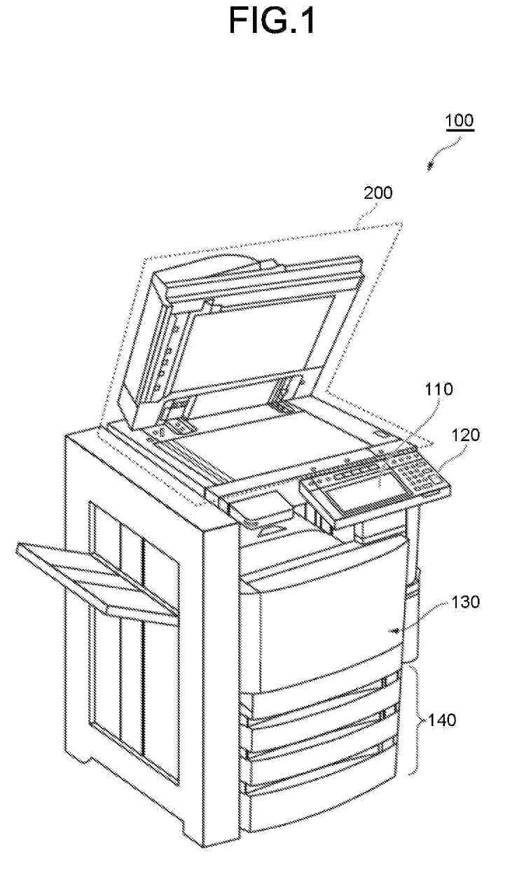

FIG. 1 is an external view illustrating an example of the exterior configuration of an image forming apparatus 100 according to the embodiment.

The image forming apparatus 100 of the embodiment is a MFP (Multi-Function Peripheral) capable of forming a toner image on a sheet. The sheet is, for example, a paper and the like on which a characters or images are recorded. The image forming apparatus 100 reads an image printed on the sheet. The image forming apparatus 100 then generates digital data and an image file. The image forming apparatus 100 has a copy function.

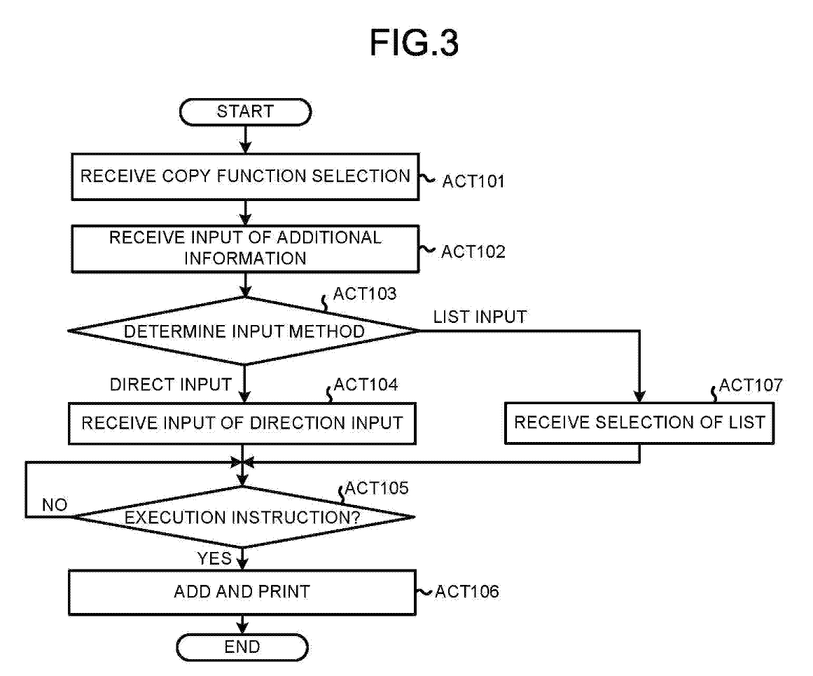

The image forming apparatus 100 includes a display 110, a control panel 120, a printer section 130, a sheet housing section 140, an image reading section 200 and a controller 300 (See FIG. 3). Further, the printer section 130 of the image forming apparatus 100 may be a device for fixing a toner image or may be an inkjet type device. In the present embodiment, a case in which the printer section 130 is the device for fixing a toner image is described as an example.

The display 110 is an image display device such as a liquid crystal display, an organic EL (Electro Luminescence) display and the like. The display 110 displays various information relating to the image forming apparatus 100. The display 110 receives information input by a user. The display 110 outputs a signal in response to an operation input by the user to a controller of the image forming apparatus 100. The display 110 receives an operation of the user. For example, the display 110 receives an instruction to copy and a selection instruction to add additional information at the time of copying. The additional information is not original print data but information added by user operation. The additional information may also be information printed on a margin of the sheet such as header or footer. Another example of the additional information is a list of information elements stored in the image forming apparatus 100 in advance, or acquired from other devices or an external memory such as a USB (Universal Serial Bus). The list may include some character strings which are frequently used by a user, an identification number (for example, employee number), a page number, an identification mark, and date information and the like. For example, the character string may be a formula or the word “confidential”.

The control panel 120 includes a plurality of buttons. The control panel 120 receives operational inputs from the user. The control panel 120 outputs a signal in response to the operational inputs of the user to the controller of the image forming apparatus 100. Further, the display 110 and the control panel 120 may be integrally configured as a touch panel.

The printer section 130 executes an image forming process. The printer section 130 forms an image on the sheet based on image data generated by the image reading section 200 or image data received via a network. The controller 300 adds the additional information, for example information input via the display 110, at the time of copying, to the image data generated by the image reading section 200 to print the additional information.

The sheet housing section 140 houses the sheets used for the image formation in the printer section 130.

The image reading section 200 reads the image information on a sheet as an intensity of light. For example, the image reading section 200 reads the image information printed on the sheet, which is the read object. The image data read by the image reading section 200 is stored in memory. The stored image data may be sent to another information processing apparatus via a network. The stored image data may be used to form an image on the sheet by the printer section 130.

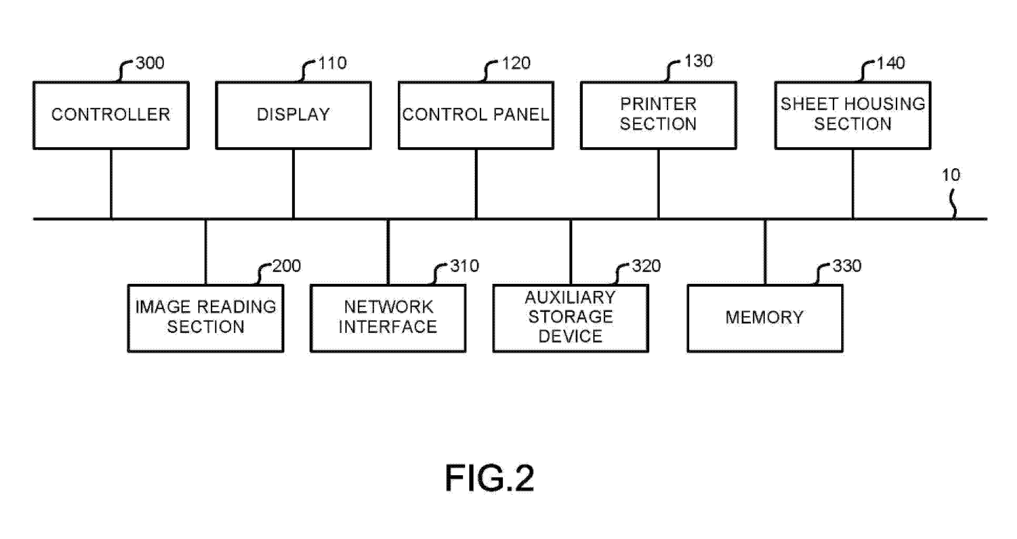

FIG. 2 is a block diagram illustrating functional components of the image forming apparatus 100.

Hereinafter, the controller 300, a network interface 310, an auxiliary storage device 320 and a memory 330 are described. Further, functional sections are connected with each other via a system bus 10 to allow communicating of data therebetween.

The controller 300 controls operation of each functional section of the image forming apparatus 100. The controller 300 executes various processed through executing a program.

The network interface 310 transmits data to, and receives data from, other devices. The network interface 310 operates as an input interface to receive data sent from other devices. For example, the network interface 310 receives the list from other devices. The network interface 310 also operates as an output interface to send the list to other devices.

The auxiliary storage device 320 is, for example, a hard disk drive or an SSD (solid state drive), and it stores various kinds of data. Various kinds of data include, for example, a list, digital data, a job and a job log. The digital data is digital data of the image generated by the image reading section 200. Furthermore, the auxiliary storage device 320 may store a plurality of lists.

The memory 330 is, for example, a RAM (Random Access Memory). The memory 330 temporarily stores data used by each functional section of the image forming apparatus 100. Furthermore, the memory 330 may store the digital data generated by the image reading section 200. The memory 330 may temporarily store the job and job log.

FIG. 3 is a flowchart illustrating the flow of processing performed by the image forming apparatus 100. The controller 300 controls the image forming apparatus 100 to execute the actions shown in the flowchart.

The display 110 receives selection by a user of the copy function for carrying out copying (ACT 101). If the copy function is selected, the display 110 receives input of the additional information (ACT 102). Herein, as part of the input of the additional information, how the additional information is input may be selected.

If the additional information is input, the display 110 notifies the controller 300 that the additional information is input. The controller 300 determines how the additional information is input according to the notification (ACT 103). In particular, the controller 300 determines whether the additional information is input through a direct input by the user, or an input by the selection of one or more items from the list by the user. If the additional information is input through the direct input (ACT 103: direct input), the controller 300 controls the display 110 to display an operation screen to receive the input (ACT 104). The operation screen may be any screen as long as it is a screen through which characters and numerals can be input. For example, the operation screen is alphabetic keys, a numeric keypad or a keyboard for inputting characters with a QWERTY arrangement.

The controller 300 determines whether or not an input of execution instruction is selected after the direct input is selected (ACT 105). The execution instruction is a button for instructing start of the copying. If the execution instruction is not selected (No in ACT 105), the controller 300 stands by until the execution instruction is selected.

On the other hand, if the execution instruction is selected (Yes in ACT 105), the controller 300 adds the input additional information and the controller 300 controls the printer section 130 to carry out printing (ACT 106). In particular, the controller 300 controls the image reading section 200 to read the image on a sheet set in the image reading section 200. The controller 300 adds the additional information to the read image data. At this time, the printer section 130 prints the read image data along with the additional information. The additional information is printed on or at the margins of the sheet. The controller 300 controls the printer section 130 to print the image data and the additional information on the sheet. In this way, the printer section 130 prints the additional information by adding the additional information to the margins of the sheet. Furthermore, the position of the printed additional information at the margins on the sheet may be preset or set by the user. Then, the processing in FIG. 3 is terminated.

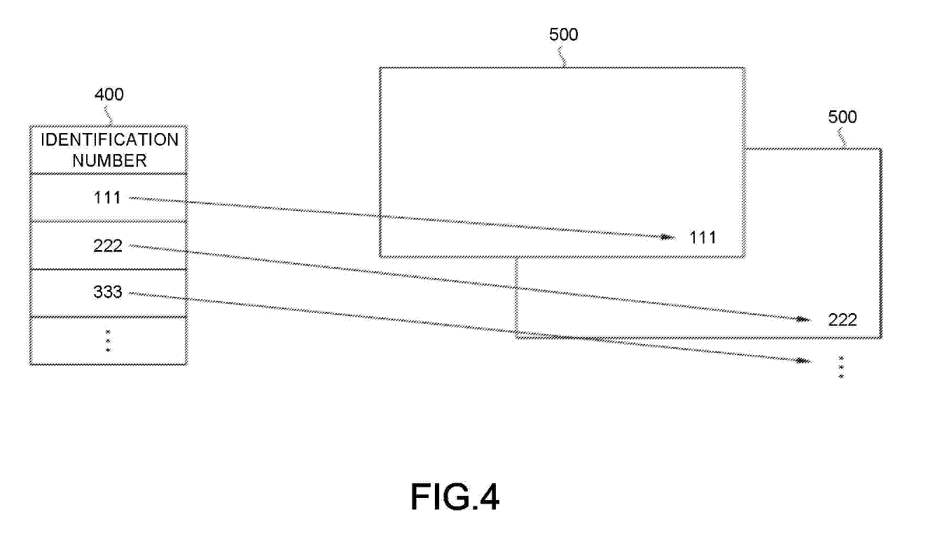

In the processing in ACT 103, if the additional information is input through an input from the list (ACT 103: list input), the controller 300 controls the display 110 to display the list in a selection screen to allow a user to input, and the controller to receive, the selection of an item from the list (ACT 107). The controller 300 controls the display 110 to display a plurality of information items stored in the list. Then, the processing subsequent to ACT 105 is executed in the same way as stated above. Herein, a print image in a case in which one or more image items from the list selected is described with reference to FIG. 4.

It is assumed that the user selects an input from the list 400 shown in FIG. 4. For example, the numbers “111”, “222”, “333”, “. . . ” are recorded in the list 400, and are selected by a user as the additional information. Then, if the execution instruction is selected, the controller 300 adds the additional information in the selected order to the read image information respectively. The controller 300 then controls the printer section 130 to print the additional information. For example, the controller 300 adds “111” as additional information to the first read sheet. The controller 300 then controls the printer section 130 to print the image data of the first-read sheet with “111” as additional information. Similarly, the controller 300 adds “222” as additional information to the image information of the second-read sheet. The controller 300 then controls the printer section 130 to print the image data of the second-read sheet with “222” as additional information. In this way, a plurality of sheets 500 shown in FIG. 4 is printed. Further, in FIG. 4, the additional information is printed in the footer of the sheet 500; however, the additional information may be printed in the header thereof.

According to the image forming apparatus 100 with the foregoing configuration, convenience of adding additional information to a printed sheet can be improved. In particular, the image forming apparatus 100 adds the information input defined by the user or the information recorded in the list to the read image data and prints the additional information. In this way, the flexibility for the printing of the additional information at the time of the copying is improved. Thus, the convenience can be improved.

Hereinafter, an exemplary modification of the image forming apparatus 100 is described.

The image forming apparatus 100 may store the additional information in advance in a state in which the additional information is added to the image data of the read sheet by the image reading section 200. For example, the image forming apparatus 100 may store the additional information in the auxiliary storage device 320 or the memory 330.

The auxiliary storage device 320 or the memory 330 (hereinafter, simply referred to as a “storage section”) may store the information defined by the user prior to printing a sheet. In such a case, the controller 300 controls the display 110 to display information stored in the storage section in a selectable manner if the information previously defined is selected by the user.

The image forming apparatus 100 maybe capable of allowing a user to select both the input of information defined by the user and an input using an input from the list as the method of inputting the additional information. In such a case, the controller 300 controls the printer section 130 to print the information which is the information defined by the user and the information of the list in the margin of the sheet. Furthermore, which of the additional information printed in either the header or the footer may be set by the user. The controller 300 may also control the printer section 130 to print the information defined by the user and the information of the list in different margins of the sheet. For example, the information defined by the user may be printed in header on the sheet, while the information of the list is printed footer on the sheet.

The controller may generate combined information as additional information. The combined information is a combination of the information defined with the information of the list. And then the controller controls the printer section to print the combined information on the sheet. For example, the combined information is printed at the footer.

In the present embodiment, if a user chooses to not request the list to select items therefrom, the controller may control the printer section 130 to print the information recorded in the list to the image information in sequence. Alternatively, the printer section 130 may print only the information selected by the user, from the information recorded in the list, to the image information. In such a case, the printer section 130 may print the selected information to the image information in order, or add the selected information to the image information in the order selected by the user.

According to at least one embodiment described above, the image forming apparatus 100 includes the image reading section 200 and the printer section 130. The image reading section 200 reads the image information printed on the sheet. The printer section 130 prints at least the information defined by the user or the information of the list in which a plurality of information is recorded in advance as additional information to the image information on the sheet.

A part of the functions of the image forming apparatus 100 according to the foregoing embodiment may be realized by a computer. In this case, programs for realizing the functions are recorded in a computer-readable recording medium. The functions may be realized by reading programs recorded in the recording medium into a computer system and executing the programs. Further, it is assumed that the “computer system” described herein contains an operating system or hardware such as peripheral devices. Further, the “computer-readable recording medium” refers to a portable medium and a storage device. The portable medium is a flexible disc, a magneto-optical disk, a ROM, a CD-ROM and the like. The storage device is a hard disk built in the computer system. Furthermore, the “computer-readable recording medium” includes a medium for dynamically containing the programs for a short time such as a communication wire in a case in which the programs are sent via a communication line. The communication line may be connected to a network such as the internet or a telephone line. The “computer-readable recording medium” may be a volatile memory in the computer system serving as a server and a client. The volatile memory stores the programs for a certain time. The foregoing programs may realize apart of the above-mentioned functions. Further, the foregoing programs may realize the above-mentioned functions with the combination of the programs already recorded in the computer system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus, comprising:
a printer section;
an image reading section configured to read image information printed on a sheet and generate image data from the image information; and
a controller configured to:
receive an input selecting, from a list including a plurality of predetermined additional items of information for printing with the image data, one of the additional items of information,
control the printer section to print, on a recording medium, the image data along with, at a margin of the recording medium, only the selected additional item of information.

2.-4. (canceled)

5. The image forming apparatus according to claim 1, further comprising:
a storage section, wherein
the list is acquired from an external memory or another device and is stored in the storage section in advance.

6. The image forming apparatus according to claim 1, further comprising:
a display section, wherein
the additional item of information that is selected is input via an operation screen displayed on the display section.

7. The image forming apparatus according to claim 1, further comprising:
a storage section; and
a display section,
wherein the controller is configured to control the storage section to store the additional item of information that was input in advance, and
to control the display section to display, in a selectable manner, the additional item of information that was input and stored in the storage section in advance.

8. The image forming apparatus according to claim 1, further comprising:
a display section, wherein
the controller is configured to control the display section to display a user defined additional item of information and the selected additional item of information.

9. The image forming apparatus according to claim 8, wherein
the controller is configured to control the display section to display, in a selectable manner, the list including the plurality of predetermined additional items of information for printing with the image data.

10. The image forming apparatus according to claim 9, wherein
the controller is configured to control the printer section to print the user defined additional item of information and the selected additional item of information from the list respectively in different areas of the sheet.

11. A method for controlling an image forming apparatus, comprising:
controlling an image reading section to read image information printed on a sheet;
generating image data from the image information;
receiving an input selecting, from a list including a plurality of predetermined additional items of information for printing with the image data, one of the additional items of information, and
printing, on a recording medium, the image data along with, at a margin of the recording medium, only the selected additional item of information.

12. (canceled)

13. The method according to claim 11, further comprising:
displaying the additional information input by the user on a display,
wherein the additional information input by the user is input using an operation screen of the display.

14. The method according to claim 11, further comprising:
storing the additional item of information that was input in advance, and
displaying the stored additional item of information on a display in a selectable manner.

15. The method according to claim 11, wherein the list includes information acquired from an external memory or from another device.

16. A non-transitory computer readable medium comprising a program that is executable in a computing device to cause the computing device to perform a method for operating an image forming apparatus, the method comprising,
controlling an image reading section to read image information printed on a sheet;
generating image data from the image information;
receiving an input selecting, from a list including a plurality of predetermined additional items of information for printing with the image data, one of the additional items of information, and
printing, on a recording medium, the image data along with, at a margin of the recording medium, only the selected additional item of information.

17. The non-transitory computer readable medium according to claim 16, wherein the method further comprises storing the list in advance.

18. The non-transitory computer readable medium according to claim 17, wherein the method further comprises
displaying the selected additional item of information on a display,
wherein the input selecting the additional item of information is input using an operation screen of the display.

19. The non-transitory computer readable medium according to claim 16, wherein the method further comprises
storing the additional item of information that was input in advance, and
displaying the stored additional item of information on a display in a selectable manner.

20. The non-transitory computer readable medium according to claim 16, wherein the list includes information acquired from an external memory or from another device.
